(19) United States
(12) Patent Application Publication
(10) Pub. No.: US 2003/0229624 A1
(43) Pub. Date: Dec. 11, 2003

(54) Search system

(76) Inventors: Greg C. Petrisor, Los Angeles, CA (US); Scot A. Reader, Sherman Oaks, CA (US)

Correspondence Address: Scot A. Reader, Esq., 3424 Woodcliff Road, Sherman Oaks, CA, 91403, US

(21) Appl. No.: 10/163,048

(22) Filed: Jun. 5, 2002

(51) Int. Cl. G06F 7/00

(52) U.S. Cl. 707/3

(57) ABSTRACT

A search system returns improved search results though recursive querying. Recursive querying is accomplished using a search agent interposed between a search client, such as a Web browser, and a search server, such as a Web search engine query server. In response to a search parameter, such as a document identifier or keyword, received from the search client, the search agent queries the search server recursively until a search result conforming to a target result parameter, such as a target Web page count, is determined. The search agent inhibits the return of intermediate, nonconforming search results to the search client, and returns the final, conforming search result to the search client.

### BACKGROUND OF THE INVENTION

The Internet hosts billions of Web pages. Millions more are added every day. The workhorse for finding information in this vast public library is the Internet search engine. Internet search engines generally require a user to manually determine search parameters, such as keywords, and manually input the search parameters into a Web browser The search parameters are translated into a search query in a syntax supported by the search engine and sent to a search engine query server. The query server resolves the query to a search result including zero or more Web page links and associated summaries and the result is returned and displayed in the Web browser.

A significant problem with conventional Internet search engines is manual query repetition. When the user-supplied search parameters are too broad, the search engine returns a large number of Web page links and associated summaries having low average relevance. This creates a “needle in the haystack” problem wherein to find the information she is seeking the user would have to sift through hundreds of irrelevant Web page summaries and visit dozens of irrelevant Web pages. Conversely, when a user inputs search parameters that are too narrow, the search engine returns few or even zero Web page links and associated summaries. This often creates a different problem wherein the information the user is seeking is not included in any of the linked-to Web pages. Faced with either problem, the user often elects to repeat the search by manually redetermining and re-inputting new search parameters. This “trial and error” approach to conducting Internet searches, extrapolated across hundreds of millions of Internet search engine users, causes a significant drain on human capital.

### SUMMARY OF THE INVENTION

The present invention, in a basic feature, provides a search system which returns improved search results through recursive querying. Recursive querying is accomplished using a search agent interposed between a search client, such as a Web browser, and a search server, such as a Web search engine query server. In response to a search parameter, such as a text identifier or a keyword, received from the search client, the search agent queries the search server recursively until a search result conforming to a target result parameter, such as a target Web page count, is determined. The search agent inhibits the return of intermediate, nonconforming search results to the search client, and returns the final, conforming search result to the search client.

In one aspect, therefore, a search system comprises a search client, a search agent, and a search server, wherein in response to a search parameter received from the search client the search agent queries the search server recursively to determine a search result conforming to a target result parameter and transmits the search result to the search client.

In another aspect, a search method comprises determining a target result parameter; determining a first search query; querying a database using the first search query to determine a first search result; determining a deviation of a parameter of the first search result and the target result parameter; and repeating or not the search depending on the deviation.

In another aspect, a search method comprises determining a first search query; querying a database using the first search query to determine a first search result; and repeating the search for a second search query determined using the first search result.

These and other aspects of the present invention will be better understood by reference to the following detailed description, taken in conjunction with the accompanying drawings briefly described below. Of course, the actual scope of the invention is defined by the appended claims.

### BRIEF DESCRPTION OF THE DRAWINGS

FIG. 1 is a schematic of a network architecture in accordance with a first preferred embodiment;

FIG. 2 is a functional diagram of a search agent operative in the network architecture according to FIG. 1;

FIG. 3 is a flow diagram of a method for optimizing a search result in the network architecture according to FIG. 1;

FIG. 4 is a schematic of a network architecture in accordance with a second preferred embodiment;

FIG. 5 is a functional diagram of a search agent operative in the network architecture according to FIG. 4;

FIG. 6 is a flow diagram of a method for optimizing a search result in the network architecture according to FIG. 4; and

FIG. 7 is a schematic of a network architecture in accordance with a third preferred embodiment.

### DETAILED DESCRIPTION OF THE PREFERRED EMBODIMENT

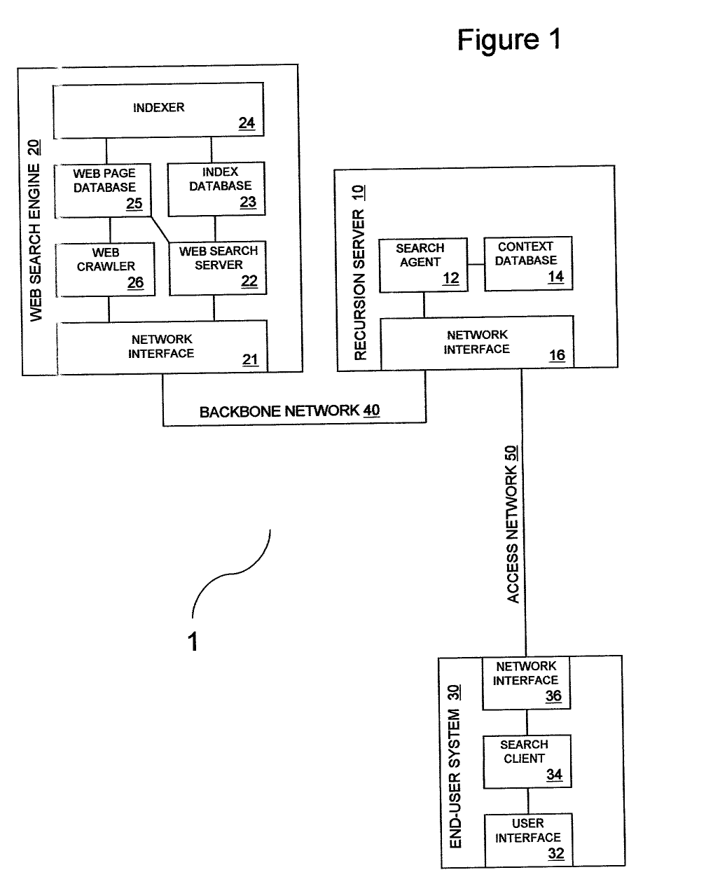

Referring to FIG. 1, a network architecture 1 in accordance with a first preferred embodiment is shown. Architecture 1 includes a recursion server 10, a Web search engine 20 and an end-user system 30. Recursion server 10 and Web search engine 20 are interconnected over a backbone network 40. Recursion server 10 and end-user system 30 are interconnected over an access network 50. Physical layer connectivity between recursion server 10, Web search server 20 and end-user system 30 may be wired or wireless or some combination thereof and may be include an arbitrary number of intermediate hops which are not shown. Data link and network layer connectivity between recursion server 10, Web search server 20 and end-user system 30 may utilize one or more local area network (LAN) and wide area network data (WAN) communication protocols such as Ethernet, Token Ring, Fiber Distributed Data Interface (FDDI), Asynchronous Transfer Mode (ATM), Frame Relay, Multiprotocol Label Switching (MPLS), Internet Protocol (IP) and Internet Packet Exchange (IPX). Recursion server 10, Web search server 20 and end-user system 30 locate one another using well-known IP addresses or Domain Name Services (DNS). End-user system 30 may be a desktop computer, notebook computer, cell phone, personal data assistant, workstation or other Web-enabled end-system. Although architecture 1 is illustrated to include three interconnected nodes, namely, recursion server 10, Web search engine 20 and end-user system 30, it will be appreciated that each of these three nodes may be interconnected to an arbitrary number of other nodes which are not shown.

End-user system 30 includes a user interface 32, a search client 34 and a network interface 36. User interface 32 is a display for viewing textual and graphical information including search results. Search client 34 is a microprocessor-driven software application, such as a general purpose Web browser, for facilitating information exchange between end-user system 30 and other nodes and for facilitating information viewing on user interface 32. Facilitation of information exchange includes accepting search requests, generating search queries from search requests, transmitting search queries and receiving search results. Accepting search requests includes accepting text identifiers and target Web page counts on user interface 32. Generating search queries includes generating from text identifiers and target Web page counts accepted on user interface 32 Uniform Resource Identifiers (URIs), as defined in, for example, Internet Engineering Task Force (IETF) Request for Comment (RFC) 2616, and encapsulating URIs in Hypertext Transfer Protocol (HTTP) GET requests, as defined in, for example, IETF RFC 2396. Transmitting search queries includes transmitting HTTP GET requests. Receiving search results includes accepting result information from network interface 36. Facilitation of information viewing includes facilitating display of result information on user interface 32. Network interface 36 is an application specific integrated circuit (ASIC)-based physical, data link and network layer device for transmitting, receiving and formatting information exchanged between end-user system 30 and other nodes.

Web search engine 20 includes a network interface 21, a Web search server 22, an index database 23, an indexer 24, a Web page database 25 and a Web crawler 26. Network interface 21 is an ASIC-based physical, data link and network layer device for transmitting, receiving and formatting information exchanged between Web search engine 20 and querying nodes. Web search server 22 is a single microprocessor-driven software application or an array of load-balanced microprocessor-driven software applications for resolving search queries to search results. Resolving a search query to a search result includes extracting a URI including a search term from an HTTP GET request received from a querying node, performing a “look up” operation in index database 23 to identify Web pages matching the search term, retrieving the Web pages from Web page database 25, ranking the Web pages by relevancy, formatting the Web pages into a search result in a Hypertext Markup Language (HTML) or Extensible Markup Language (XML) format and returning the search result to the querying node. Matching of a search term and a Web page may be defined in relation to, for example, inclusion in the Web page of all mandatory elements of the search term. Relevancy of a Web page may be defined in relation to, for example, the inclusion in the Web page of mandatory and recommended elements of the search term. Index database 23 includes one or more data stores having word-to-Web page associations. Web crawler 26 is a microprocessor-based software application that visits Web servers hosting websites, extracts Web pages therefrom and stores the Web pages in Web page database 25. Indexer 24 adds to index database 23 word-to-Web page associations for Web pages stored in Web page database 25. While Web search engine 20 is shown as a single network node, Web search engine 20 may be implemented as an intranet having any number of network nodes.

Recursion server 10 includes a network interface 16, a search agent 12 and a context database 14. Context database 14 includes data stores having context information for use in generating from front-end search queries received from search client 34 back-end search queries for transmission to Web search server 22. Search agent 12 is a microprocessor-driven software application interfacing with search client 34 over access network 50, with Web search server 22 over backbone network 40, and locally with context database 14. Search agent 12, through judicious accesses of context database 14 and intelligent application of context information retrieved from such accesses, represents search client 34 in a recursive querying session with Web search server 22 to determine a conforming search result for return to search client 34. Representation of search client 34 includes receiving by search agent 12 of a front-end search query (e.g. first HTTP GET request) from search client 34 having a text identifier and a target Web page count (e.g. in a URI); performing a “look up” operation in context database 14 using the text identifier to retrieve context information; shaping the context information into a search term including status identifiers; forming a back-end search query (e.g. second HTTP GET request) including the search term; and transmitting the back-end search query to Web search server 22. Representation of search client 34 further includes receiving a back-end search result from Web search server 22; comparing for proximity the Web page count of the back-end search result with the target Web page count; and, depending on the proximity, either (a) modifying the search term using the Web page count of the back-end search result and repeating the back-end representation of search client 34 for the modified search term, or (b) forming a front-end search result using the back-end search result and transmitting the front-end search result to the search client 34. In this regard, if the proximity is not within a predetermined proximity, approach (a) (i.e. further recursion) is followed. If the proximity is within the predetermined proximity, approach (b) (i.e. no further recursion) is followed. Network interface 16 is an application specific integrated circuit (ASIC)-based physical, data link and network layer device for transmitting, receiving and formatting information exchanged between recursion server 10 and other nodes.

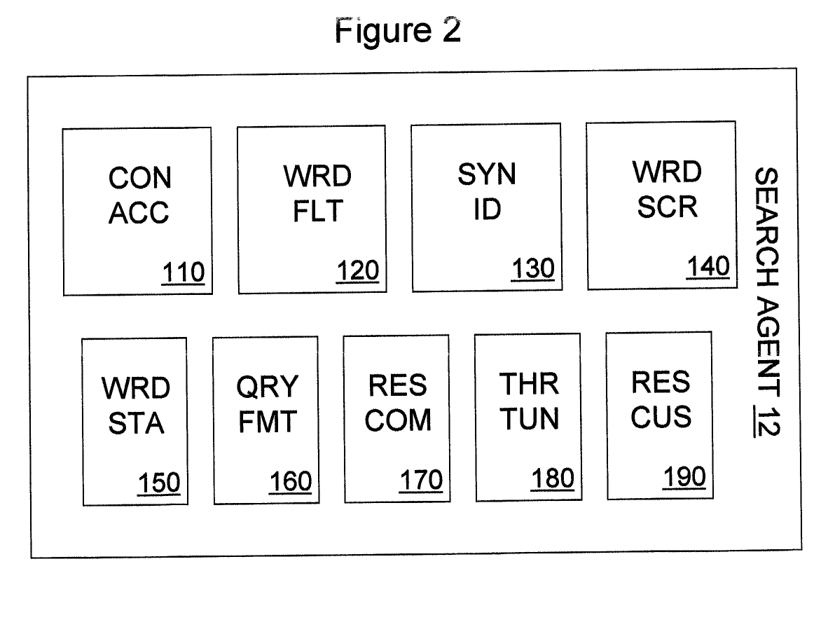

A functional diagram of search agent 12 is shown in FIG. 2. Agent 12 performs a context access (CON ACC) function 110. CON ACC 110 serves, after receipt of a front-end query from search client 34, to extract a text identifier therefrom, perform a “look up” operation in context database 14 using the text identifier and retrieve a primary context associated with the text identifier. The text identifier may be, for example, a document identifier and/or a document section identifier. Primary context may be, for example, a document or a document section identified using the text identifier. By way of example, context database 14 may include full-text patents. The text identifier may be a patent number and a patent claim number and primary context “looked up” in context database 14 may be the text of a patent claim corresponding to the patent number and the patent claim number.

Agent 12 also performs a word filtering (WRD FLT) function 120. WRD FLT 120 serves, after retrieval of the primary context, to eliminate low value words therefrom. Low value words include words which, if included in a search term, would tend to reduce the relevancy of a corresponding search result. Low value words include, by way of example, articles, conjunctions and prepositions. WRD FLT 120 includes “looking up” the words of the primary context in a search control list maintained on recursion server 10 and eliminating from the primary context words found in the list.

Agent 12 also performs a synonym identification (SYN ID) function 130. SYN ID 130 serves, after elimination of low value words from the primary context, to identify synonyms for the remaining words and assemble the remaining words and their synonyms into word “bundles”. SYN ID 130 includes “looking up” the remaining words in a thesaurus maintained on recursion server 10 and grouping them with their associated words. Words may be individual words or phrases. Thus, each word bundle may include zero or more individual words and zero or more phrases.

Agent 12 also performs a word scoring (WRD SCR) function 140. WRD SCR 140 serves, after grouping of the remaining words of the primary context into word bundles, to score and rank the word bundles. To score the word bundles, WRD SCR 140 employs a weighted voting scheme that tallies a vote count for each word bundle based on the number of uses of words in the bundle in context sources for the primary context (i.e. secondary context sources) and the relevancy of the secondary context source where the uses occur. Each use of a word in a bundle in a secondary context source is counted as one or more “votes” for the word bundle, with the number of votes added to a word bundle's vote tally per instance of use depending on the relevancy of the secondary context source that uses the word. Continuing the above example where the primary context is a patent claim text, secondary context sources may include, for example, the claims of the subject patent, the abstract of the subject patent, the specification of the subject patent, the claims, abstracts and specifications of the subject patent's backward patent citations and the claims, abstracts and specifications of the subject patent's forward patent citations. Backward patent citations are patents cited as references by the subject patent. Forward patent citations are patents that cite the subject patent as a reference. Preferably, each secondary context source is assigned a weight representing the number of votes added to a word bundle's vote tally per instance of use in the secondary context source. To rank the word bundles, WRD SCR 140 translates each word bundle's vote count into a percentile relative to the other word bundles [e.g. the word bundle having the Xth highest vote count among N word bundles translates into the 100(1−X/N)th percentile].

Agent 12 also performs a word status (WRD STA) function 150. WRD STA 150 serves, after scoring and ranking of the word bundles by WRD SCR 140 in preparation for an initial back-end query, or after receiving a recursion notification in preparation for a recursive back-end query, to determine status identifiers for the word bundles. WRD STA 150 compares each word bundle's percentile with one or more status thresholds to determine the word bundle's status with respect to the back-end query search term. Word bundles whose percentile meets or exceeds a mandatory status threshold are included in the search term and are identified as “mandatory” search elements. Word bundles whose percentile does not meet or exceed the mandatory status threshold but meets or exceeds a recommended status threshold are included in the search term and are identified as “recommended” search elements. Word bundles whose percentile does not meet or exceed the recommended status threshold are excluded from the search term. For the initial back-end query, initial values of the status thresholds are used. The initial values are determined based on the target Web page count. By way of example, where the target result parameter identifies 100 as the target number of Web page links to be returned in a search result the initial value of the mandatory status threshold may be set at 60 percent and the initial value of the recommended status threshold may be set at 20 percent. In that event, word bundles whose percentile is greater than or equal to 60 may be included in the search term and identified as mandatory. Word bundles whose percentile is between 20 and 60 may be included in the search term and identified as recommended. Word bundles whose percentile is below 20 may be excluded from the search term. Identification of a word bundle as mandatory indicates to Web search server 22 that a Web page location must include at least one word in the bundle to be included in the search result. Identification of a word bundle as recommended indicates to the Web search server 22 to give an increased ranking to a Web page location included in the search result if it includes at least one word in the bundle. For recursive back-end queries, adjusted values of the status thresholds are used. Adjusted values are determined by a threshold tuning (THR TUN) function 180 based on a measured deviation of the Web page count of the immediately preceding back-end result and the target Web page count.

Agent 12 also performs a query formatting (QRY FMT) function 160. QRY FMT 160 serves, after the determination of the status of word bundles (e.g. mandatory, recommended, excluded), to form a back-end query with the search term including the mandatory and recommended word bundles and associated status identifiers. QRY FMT 160 includes resolving the search term to a URI using query syntax specified for Web search server 22, encapsulating the URIs in an HTTP GET request and transmitting the HTTP GET request to Web search server 22.

Agent 12 also performs a result compare (RES COM) function 170. RES COM 170 serves, after the receipt of a back-end result from Web search server 22, for comparing for proximity the Web page count of the back-end result and the target Web page count. RES COM 170 reviews the back-end result received from Web search server 22 and determines a back-end Web page count therefrom. RES COM 170 compares the back-end Web page count with the target Web page count received from search client 34 in the front-end query to determine a measured deviation. If the absolute value of the measured deviation exceeds a predetermined limit deviation, RES COM 170 provides a recursion notification to threshold tuning function (THR TUN) 180 instructing to proceed with recursive querying. If the absolute value of the measured deviation is less than or equal to the predetermined limit deviation, RES COM 170 provides a completion notification to result customization (RES CUS) function 190 instructing to proceed with front-end result generation. By way of example, where the target Web page count is 100 and the predetermined limit deviation is 10 percent, RES COM 170 provides a completion notification to RES CUS 190 if the back-end Web page count is between 90 and 110, and otherwise provides a recursion notification to THR TUN 180.

Agent 12 also performs a threshold tuning (THR TUN) function 180. THR TUN 180 serves, after receipt of a recursion notification from RES COM 170, to adjust at least the mandatory status threshold upward or downward in accordance with the measured deviation. If the measured deviation is positive (e.g. back-end Web page count exceeds target Web page count by more than 10 percent), the back-end result is over-target and THR TUN 180 decreases the mandatory status threshold to increase the number of mandatory word bundles in the search term for the next back-end query. If the measured deviation is negative (e.g. target Web page count exceeds the back-end Web page count by more than 10 percent), the back-end result is under-target and THR TUN 180 increases the mandatory status threshold to reduce the number of mandatory word bundles in the search term for the next back-end query. By way of example, the increase or decrease in the mandatory status threshold may be 10 percent (e.g. increase from 60 percent to 70 percent or decrease from 60 percent to 50 percent). THR TUN 180 relays the recursion notification to WRD STA 150.

Agent 12 also performs a result customization (RES CUS) function 190. RES CUS 190 serves, after receipt of a back-end result in a standard HTML or XML display format from Web search server 22 and a completion notification from RES COM 170, to generate a front-end result for display by search client 34 and transmit the front-end result to search client 34. Continuing the above patent example, result customization may include a formatting instruction for displaying the subject patent or the patent claim text in the front-end result or a formatting instruction for displaying the patent-relevant Web page links and summaries returned in the front-end result.

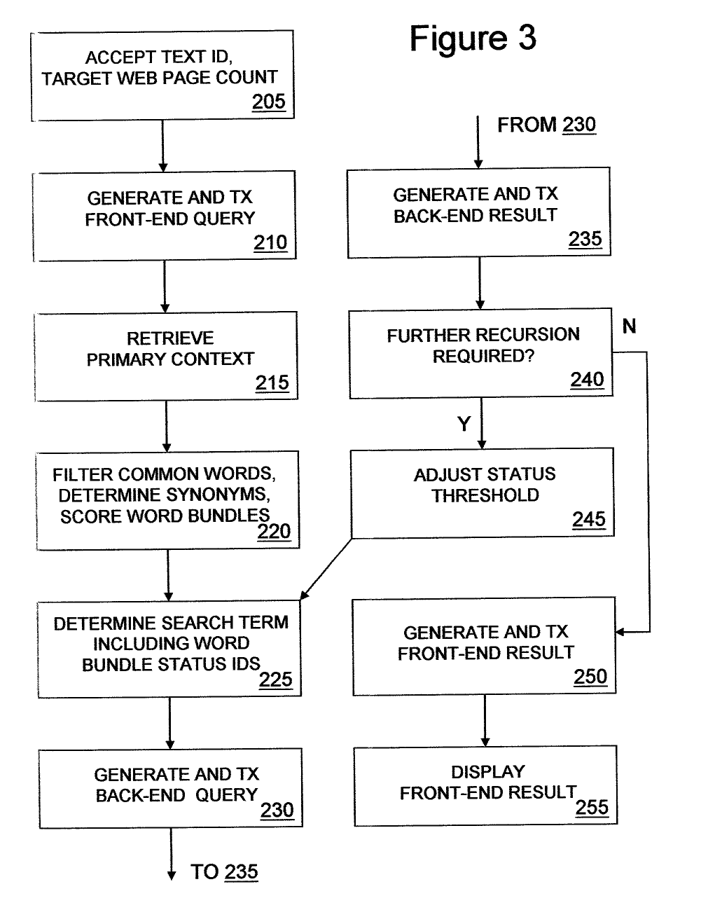

Turning to FIG. 3, a flow diagram illustrates a preferred method for implementing the first preferred embodiment. On end-user system 30, search client 34 accepts a text identifier and a target Web page count (205). Text identifier and target Web page count may be “keyed in” on user interface 32 or may be implicit in mouse click selections made on user interface 32. Search client 34 generates a front-end query including the text identifier and target Web page count and transmits the front-end query to recursion server 10 (210). On recursion server 10, search agent 34 performs a context access (CON ACC) function 110 and retrieves a primary context associated with the text identifier (215). Search agent 34 applies a word filtering (WRD FLT) function 120, a synonym identification (SYN ID) function 130 and a word scoring (WRD SCR) function 140 (220), followed by a word status (WRD STA) function 150 (225), to shape the primary context into a search term including status identifiers. Search agent 34 performs a query formatting (QRY FMT) function 160 and forms a back-end query with the search term and transmits the back-end query to Web search engine 20 (230). On Web search engine 20, Web search server 22 resolves the back-end query to a back-end result including Web page links and summaries relevant to the back-end query and transmits the back-end result to recursion server 10 (235). On recursion server 10, search agent 34 performs a result compare (RES COM) function 170 comparing the back-end Web page count and the target Web page count to determine whether further recursion is required (240). If further recursion is required, search agent 34 performs a threshold tuning (THR TUN) function 180 adjusting at least the mandatory status threshold (245) and the process returns to Step 225. If further recursion is not required, search agent 34 performs a result customization (RES CUS) function 190 to generate a front-end result for display by search client 34 and transmits the front-end result to end-user station 30 (250). On end-user station 30, search client 34 facilitates display of the front-end result on user interface 32 (255).

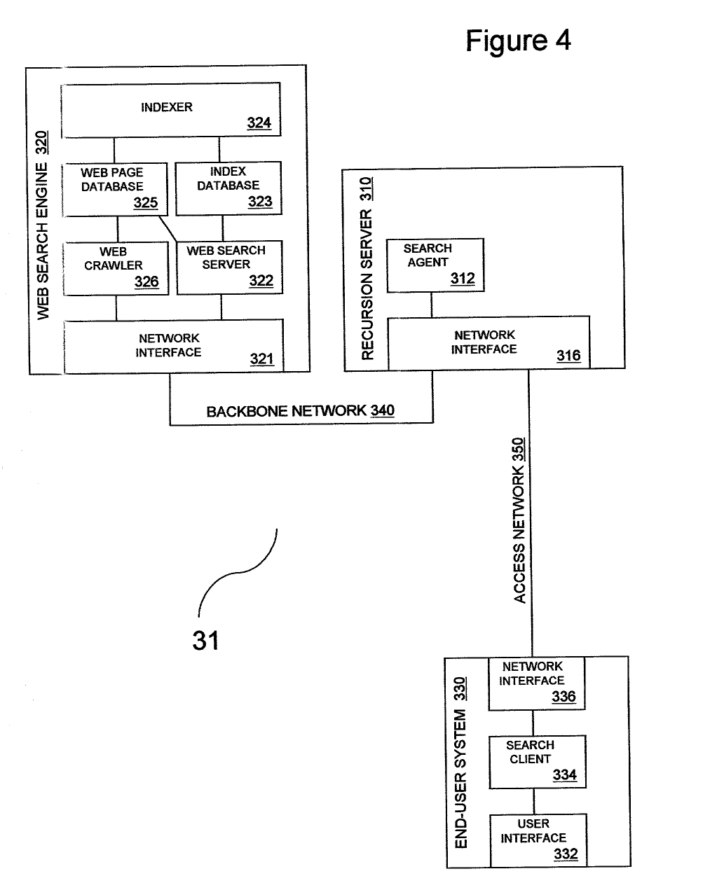

Turning now to FIG. 4, in a second preferred embodiment, a network architecture 31 includes a recursion server 310, a Web search engine 320 and an end-user system 330 interconnected via a backbone network 340 and an access network 350. In the second preferred embodiment, user-supplied keywords and keyword rankings are used in resolving search terms including status identifiers applied in back-end queries.

Web search engine 320 includes a network interface 321, a Web search sever 322, an index database 323, an indexer 324, a Web page database 325 and a Web crawler 326 operatively identical to their counterparts network interface 21, Web search server 22, index database 23, indexer 24, Web page database 25 and Web crawler 26 described in the first preferred embodiment.

End-user system 330 includes a user interface 332, a search client 334 and a network interface 336 operatively identical to their counterparts user interface 332, a search client 334 and a network interface 336 described in the first preferred embodiment, except as follows: Accepting search requests includes accepting keywords, keyword rankings and target Web page counts on user interface 332. Generating search queries includes generating from keywords, keyword rankings and target Web page counts accepted on user interface 332 Uniform Resource Identifiers (URIs), as defined in, for example, Internet Engineering Task Force (IETF) Request for Comment (RFC) 2616, and encapsulating URIs in Hypertext Transfer Protocol (HTTP) GET requests, as defined in, for example, IETF RFC 2396.

Backbone network 340 and access network 350 are operatively identical to their counterparts backbone network 40 and access network 50 described in the first preferred embodiment.

Recursion server 310 includes a network interface 316 operatively identical to network interface 16 described in the first preferred embodiment. Recursion server 310 further includes search agent 312. Search agent 312 is a microprocessor-driven software application interfacing with search client 334 over access network 350 and with Web search server 322 over backbone network 340. Search agent 312 intelligently integrates keywords and keyword rankings received from search client 334 and represents search client 334 in a recursive querying session with Web search server 322 to determine a conforming search result for return to search client 334. Representation of search client 334 includes receipt by search agent 312 of a front-end query (e.g. first HTTP GET request) from search client 334 having keywords, keyword rankings and a target Web page count (e.g. in a URI); shaping the keywords into a search term including status identifiers using the keyword rankings; forming a back-end query (e.g. second HTTP GET request) including the search term; and transmitting the back-end query to Web search server 322. Representation of search client 334 further includes receiving a back-end result from Web search server 322; comparing for proximity the Web page count of the back-end result and the target Web page count; and, depending on the proximity, either (a) generating a modified search term using the Web page count of the back-end result and repeating the back-end representation of search client 334 for the modified search term, or (b) forming a front-end result using the back-end result and transmitting the front-end result to the search client 334. In this regard, if the proximity is not within a predetermined proximity, approach (a) (i.e. further recursion) is followed. If the proximity is within the predetermined proximity, approach (b) (i.e. no further recursion) is followed.

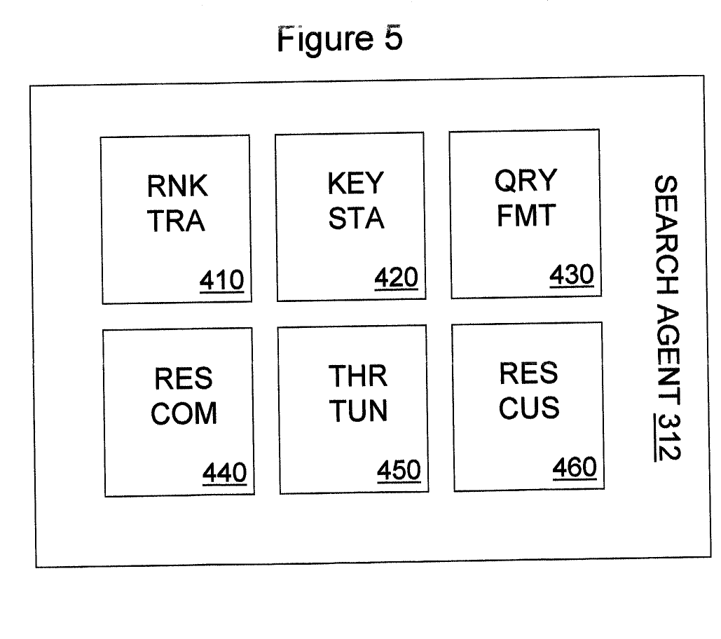

A functional diagram of search agent 312 is shown in FIG. 5. Agent 312 performs a rank translation (RNK TRA) function 410. RNK TRA 410 serves, after receipt of a front-end query from search client 334, to extract the keywords and keyword rankings and translate each keyword's ranking into a percentile ranking [e.g. the keyword ranking that is the Xth highest among N rankings translates into the 100(1−X/N)th percentile]. A keyword may be a word or a phrase. Each keyword ranking includes a ranking of a keyword relative to the other keywords based on the user's assessment of the importance of having the subject keyword included in Web pages returned in the search result.

Agent 312 also performs a keyword status (KEY STA) function 420. KEY STA 420 serves, in preparation for an initial back-end query or a recursive back-end query, to determine the status of the keywords with respect to the search term. KEY STA 420 compares each keyword's rank percentile with a mandatory status threshold to determine the keyword's status. Keywords whose percentile meets or exceeds the mandatory status threshold are included in the search term and are identified as mandatory. Keywords whose percentile does not meet or exceed the mandatory status threshold are included in the search term and are identified as recommended. For the initial back-end query, the initial value of the mandatory status threshold is used. The initial value is determined based on the target Web page count. By way of example, where the target Web page count identifies 100 as the target number of Web page links to be returned in a search result, the initial value of the mandatory status threshold may be 50. In that event, keywords whose rank percentile is greater than or equal to 50 may be included in the search term and identified as mandatory. Keywords whose rank percentile is between 0 and 50 may be included in the search term and identified as recommended. Identification of a keyword as mandatory indicates to Web search server 322 that a Web page location must include the keyword to be included in the search result. Identification of a keyword as recommended indicates to the Web search server 322 to give an increased ranking to a Web page location included in the search result if it includes the keyword. For recursive back-end queries, an adjusted value of the mandatory status threshold is used. Adjusted values are determined by a threshold tuning (THR TUN) function 450 based on a measured deviation of the Web page count of the immediately preceding back-end result and the target Web page count.

Agent 312 also performs a query formatting (QRY FMT) function 430. QRY FMT 430 serves, after the determination of the status of keywords with respect to the search term (e.g. mandatory or recommended), to form a back-end query with the search term including status identifiers. QRY FMT 430 includes resolving the search term to a URI using query syntax specified for Web search server 322, encapsulating the URIs in an HTTP GET request and transmitting the HTTP GET request to Web search server 322.

Agent 312 also performs a result compare (RES COM) function 440. RES COM 440 serves, after the receipt of a back-end result from Web search server 322, for comparing for proximity the Web page count of the back-end result and the target Web page count. RES COM 440 reviews the back-end result received from Web search server 322 and determines the back-end Web page count. RES COM 440 compares the back-end Web page count and the target Web page count received from search client 334 in the front-end query to determine a measured deviation. If the absolute value of the measured deviation exceeds a predetermined limit deviation, RES COM 440 provides a recursion notification to threshold tuning function (THR TUN) 450 instructing to proceed with recursive querying. If the absolute value of the measured deviation is less than or equal to the predetermined limit deviation, RES COM 440 provides a completion notification to result customization (RES CUS) function 460 instructing to proceed with front-end result generation. By way of example, where the target Web page count is 100 and the predetermined limit deviation is 10 percent, RES COM 440 provides a completion notification to RES CUS 460 if the back-end Web page count is between 90 and 110, and otherwise provides a recursion notification to THR TUN 450.

Agent 312 also performs a threshold tuning (THR TUN) function 450. THR TUN 450 serves, after receipt of a recursion notification from RES COM 440, to adjust the mandatory status threshold upward or downward in accordance with the measured deviation. If the measured deviation is positive (e.g. back-end Web page count exceeds target Web page count by more than 10 percent), the back-end result is over-target and THR TUN 450 decreases the mandatory status threshold to increase the number of mandatory keywords in the search term. If the measured deviation is negative (e.g. target Web page count exceeds back-end Web page count by more than 10 percent), the back-end result is under-target and THR TUN 450 increases the mandatory status threshold to reduce the number of mandatory keywords in the search term. By way of example, the increase or decrease in the mandatory status threshold may be 10 percent (e.g. increase from 60 percent to 70 percent or decrease from 60 percent to 50 percent). THR TUN 450 relays the recursion notification to KEY STA 420.

Agent 312 also performs a result customization (RES CUS) function 460. RES CUS 460 serves, after receipt of a back-end result in a standard HTML or XML display format from Web search server 322 and a completion notification from RES COM 440, to generate a front-end result for display by search client 334 and transmit the front-end result to search client 334.

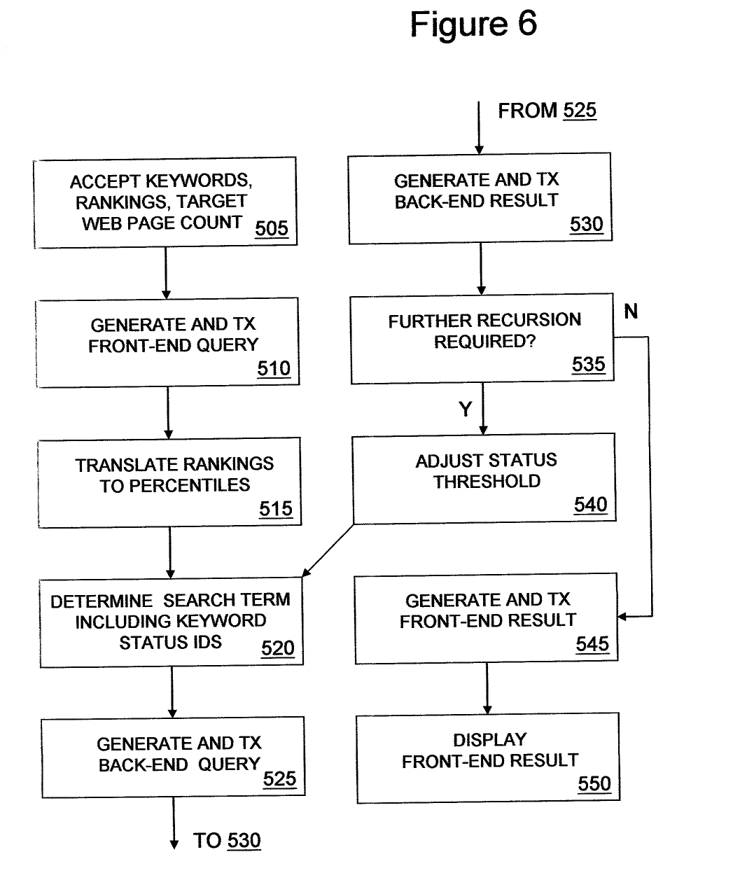

Turning to FIG. 6, a flow diagram illustrates a preferred method for implementing the second preferred embodiment. On end-user system 330, search client 334 accepts keywords and associated rankings, and a target Web page count (505). Keywords, rankings and target Web page count may be “keyed in” on user interface 332 or may be implicit in mouse dick selections made on user interface 332. Search client 334 generates a front-end query including the keywords, rankings and target Web page count and transmits the front-end query to recursion server 310 (510). On recursion server 310, search agent 334 performs a ranking translation (RNK TRA) function 410 and converts the rankings into percentiles (515). Search agent 334 applies a keyword status (KEY STA) function 420 (520) to shape the keywords into a search term including status identifiers. Search agent 334 performs a query formatting (QRY FMT) function 430 and forms a back-end query with the search term including status identifiers and transmits the back-end query to Web search engine 320 (525). On Web search engine 320, Web search server 322 resolves the back-end query to a back-end result including Web page links and summaries relevant to the back-end query and transmits the back-end result to recursion server 310 (530). On recursion server 310, search agent 334 performs a result compare (RES COM) function 440 comparing the Web page count of the back-end result and the target Web page count to determine whether further recursion is required (535). If further recursion is required, search agent 334 performs a threshold tuning (THR TUN) function 450 adjusting the mandatory status threshold (540) and the process returns to Step 520. If further recursion is not required, search agent 334 performs a result customization (RES CUS) function 460 to generate a front-end result for display by search client 334 and transmits the front-end result to end-user station 330 (545). On end-user station 330, search client 334 facilitates display of the front-end result on user interface 332 (550).

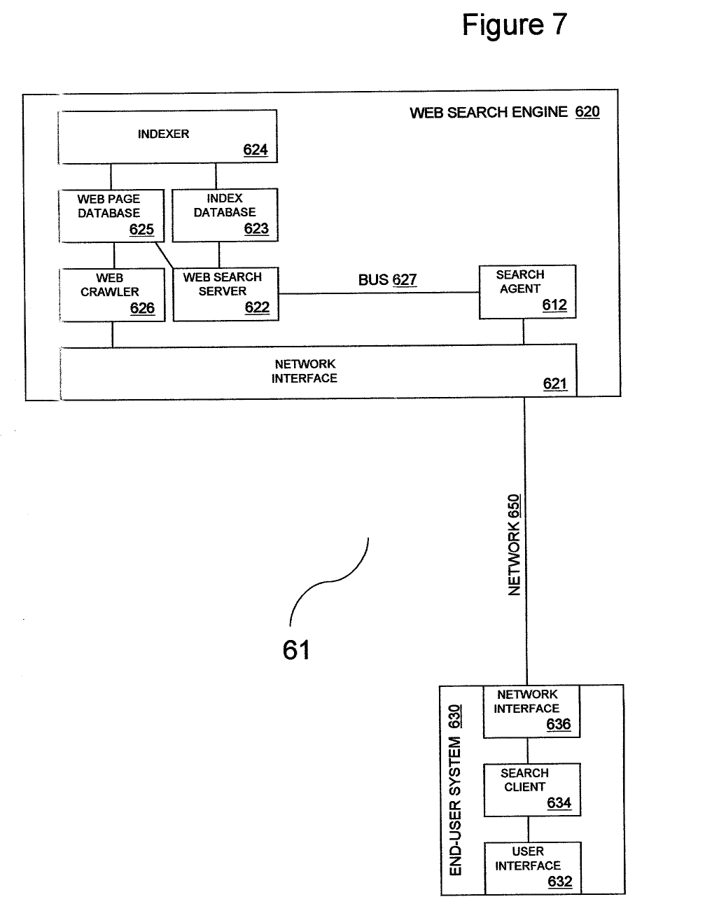

Turning finally to FIG. 7, in a third preferred embodiment, a network architecture 61 includes a Web search engine 620 and an end-user system 630 interconnected via a network 650. In the third preferred embodiment, search agent 612 and Web search server 622 are co-located at Web search engine 620 and communicate over a bus 627.

Web search engine 620 includes a network interface 621, index database 623, an indexer 624, a Web page database 625 and a Web crawler 626 operatively identical to their counterparts in the first and second preferred embodiments.

Web search engine 620 includes a Web search server 622 and search agent 612 operatively identical to their counterparts Web search server 322 and search agent 312 in the second preferred embodiment, except Web search server 622 and search agent 612 are co-located on Web search engine 620 and exchange back-end queries and back-end results over bus 627. Bus 627 is a data line interconnecting Web search server 622 and search agent 612 using a standard local area network (LAN) communication protocol such as Ethernet, Token Ring, Fiber Distributed Data Interface (FDDI) or, alternatively, a proprietary bus protocol.

End-user system 630 includes a user interface 632, a search client 634 and a network interface 636 operatively identical to their counterparts user interface 332, search client 334 and network interface 336 in the second preferred embodiment, except end-user system 630 exchanges front-end queries and front-end results with Web search engine 620.

It will be appreciated by those of ordinary skill in the art that the invention can be embodied in other specific forms without departing from the spirit or essential character hereof. The present invention is therefore considered in all respects to be illustrative and not restrictive. The scope of the invention is indicated by the appended claims, and all changes that come within the meaning and range of equivalents thereof are intended to be embraced therein.

What is claimed is:

1. A search system, comprising:
a search client;
a search agent; and
a search server,
wherein in response to information received from the search client the search agent queries the search server recursively to determine a search result conforming to a target result parameter and transmits the search result to the search client.

2. The system of claim 1, wherein the target result parameter is a target Web page count.

3. The system of claim 1, wherein the search client is a Web browser.

4. The system of claim 1, wherein the search server is a Web search engine query server.

5. The system of claim 1, wherein the search client, the search agent and the search server reside on a first, second and third network node, respectively.

6. The system of claim 1, wherein the search client resides on a first network node and the search agent and search server reside on a second network node.

7. A search method, comprising the steps of:
determining a target result parameter;
determining a search query;
querying a database using the search query to determine a search result;
determining a deviation of a parameter of the search result and the target result parameter; and
repeating or not the second and third steps depending on the deviation.

8. The method of claim 7, wherein the parameter of the search result and the target result parameter are Web page counts.

9. The method of claim 7, wherein the second and third steps are repeated if the deviation exceeds a predetermined deviation.

10. The method of claim 7, wherein the second and third steps are not repeated if the deviation does not exceed a predetermined deviation.

11. A search method, comprising the steps of:
determining a first search query;
querying a database using the first search query to determine a first search result;
determining a second search query using the first search result; and
querying the database using the second search query to determine a second search result.

12. The method of claim 11, wherein the use of the first search result includes determining a search term for the second search query using a parameter of the first search result.

13. The method of claim 12, wherein the parameter of the first search result is a Web page count.

14. A search system, comprising:
a search client;
a search agent; and
a search server,
wherein the search agent applies information received from the search client to determine a first search query and transmits the first search query to the search server, in response to which the search server applies the first search query to determine a first search result and transmits the first search result to the search agent, in response to which the search agent determines a deviation of a parameter of the first search result and a target result parameter and transmits or not a second search query to the search server depending on the deviation.

15. The system of claim 14, wherein the parameter of the first search result and the target result parameter are Web page counts.

16. The system of claim 14, wherein the search agent transmits the second search query to the search server if the deviation exceeds a predetermined deviation.

17. The system of claim 14, wherein the search agent fails to transmit the second search query to the search server if the deviation does not exceed a predetermined deviation.

18. The system of claim 14, wherein the search agent transmits the first search result to the search client if the deviation does not exceed a predetermined deviation.

19. The system of claim 14, wherein the search agent inhibits transmission of the first search result to the search client if the deviation exceeds a predetermined deviation.

20. The system of claim 14, wherein the second search query is determined using the first search result.

21. A search system, comprising:
a search client;
a search agent; and
a search server,
wherein the search agent applies information received from the search client to determine a first search query and transmits the first search query to the search server, in response to which the search server applies the first search query to determine a first search result and transmits the first search result to the search agent, in response to which the search agent determines a second search query using the first search result and transmits the second search query to the search server.

22. The system of claim 21, wherein the search agent inhibits transmission of the first search result to the search client.

23. The system of claim 21, wherein the search agent further uses the first search result to determine a deviation of a parameter of the first search result and a target result parameter.

24. The system of claim 23, wherein the parameter of the first search result and the target result parameter are Web page counts.

25. The system of claim 23, wherein the search agent determines whether the deviation exceeds a predetermined deviation.

26. A search system, comprising:
a search client;
a search agent; and
a search server,
wherein the search client transmits a plurality of keywords and associated rankings to the search agent and the search agent applies the plurality of keywords and the associated keyword rankings in a recursive querying session with the search server to determine a search result conforming to a target result parameter, and wherein the search result is transmitted to the search client.

27. The system of claim 26, wherein the target result parameter is a target Web page count.

28. The system of claim 26, wherein the search client is a Web browser.

29. The system of claim 26, wherein the search server is a Web search engine query server.

30. The system of claim 26, wherein the search client, the search agent and the search server reside on a first, second and third network node, respectively.

31. The system of claim 26, wherein the search client resides on a first network node and the search agent and the search server reside on a second network node.

32. The system of claim 26, wherein the plurality of keywords are selected from the group consisting of words and phrases.

33. The system of claim 26, wherein the associated rankings include discrete rankings of the keywords from one to the number of keywords in the plurality.

34. A communication network, comprising:
a first node;
a second node; and
a third node,
wherein in response to information received from the first node the second node queries the third node recursively to determine a search result conforming to a target result parameter and transmits the search result to the first node.

35. The network of claim 34, wherein the target result parameter is a target Web page count.

36. The network of claim 34, wherein the first node is an end-user system.

37. The network of claim 34, wherein the second node is a recursion server.

38. The network of claim 34, wherein the third node comprises a Web search engine query server.

39. A communication network, comprising:
a first node; and
a second node;
wherein in response to information received from the first node the second node applies the information in a recursive querying session to determine a search result conforming to a target result parameter and transmits the search result to the first node.

40. The network of claim 39, wherein the target result parameter is a target Web page count.

41. The network of claim 39, wherein the first node is an end-user system.

42. The network of claim 39, wherein the second node comprises a Web search engine query server.
